(19) United States
(12) Patent Application Publication
(10) Pub. No.: US 2015/0088568 A1
(43) Pub. Date: Mar. 26, 2015

(54) METHODS FOR MATCHING CANDIDATE WITH A JOB AND DEVICES THEREOF

(71) Applicant: Erin Rae Lambroschini, London (GB)

(72) Inventor: Erin Rae Lambroschini, London (GB)

(21) Appl. No.: 14/036,231

(22) Filed: Sep. 25, 2013

(51) Int. Cl. G06Q 10/06

(52) U.S. Cl. CPC G06Q 10/063112
USPC 705/7.14

(57) ABSTRACT

A method, non-transitory computer readable medium, and a job match management computing device include obtaining candidate information and one or more job skills of one or more candidates at one or more candidate computing devices. One or more required skills of one or more job opportunities is also obtained. The one or more candidates with the obtained job skills which at least partially match the obtained required skills of one or more of the job opportunities is identified. The identified at least partial matches between the one or more candidates and the one or more job opportunities are provided.

### FIELD

This technology generally relates to searching and matching of two data sets, more particularly, to methods for matching candidate with a job and devices thereof.

### BACKGROUND

Often, corporate and other employers seek talented employees for a position available within their organization. Generally, job descriptions for job opportunities are created and then advertised through internet, printed media among other channels. Job seekers then have to review and analyze these descriptions in order to determine if they satisfy the job requirements.

Existing technologies provides searching tools to a person searching for jobs on internet. Typical searching tools include the job seeker selecting various criteria in the form of keywords, such as desired locations, types of jobs, and desired compensation, making the process of using the accurate keywords extremely important. Unfortunately, when a job seeker does not accurate use keywords for the job search, he/she may miss out on job opportunities which may be perfectly suited for their skill set.

### SUMMARY

A method for matching candidate with a job includes a job match management computing device for obtaining candidate information and one or more job skills of one or more candidates at one or more candidate computing devices. One or more required skills of one or more job opportunities is also obtained by the job match management computing device. The one or more candidates with the obtained job skills which at least partially match the obtained required skills of one or more of the job opportunities is identified by the job match management computing device. The identified at least partial matches between the one or more candidates and the one or more job opportunities are provided by the job match management computing device.

A non-transitory computer readable medium having stored thereon instructions for matching candidate with a job comprising machine executable code which when executed by at least one processor, causes the processor to perform steps including obtaining candidate information and one or more job skills of one or more candidates at one or more candidate computing devices. One or more required skills of one or more job opportunities is also obtained. The one or more candidates with the obtained job skills which at least partially match the obtained required skills of one or more of the job opportunities is identified. The identified at least partial matches between the one or more candidates and the one or more job opportunities are provided.

A job opportunity management computing device comprising one or more processors, a memory, wherein the memory coupled to the one or more processors which are configured to execute programmed instructions stored in the memory including obtaining candidate information and one or more job skills of one or more candidates at one or more candidate computing devices. One or more required skills of one or more job opportunities is also obtained. The one or more candidates with the obtained job skills which at least partially match the obtained required skills of one or more of the job opportunities is identified. The identified at least partial matches between the one or more candidates and the one or more job opportunities are provided.

This technology provides a number of advantages including providing more effective methods, non-transitory computer readable medium and apparatuses for searching and matching candidates with job opportunities. With this technology, the searching and matching of job opportunities with a job seeker does not rely solely upon traditional keywords entries but also has the ability to provide a more accurate match based on previously identified job skill and sub skill sets.

### BRIEF DESCRIPTION OF THE DRAWINGS

FIG. 1 is a block diagram of an exemplary job match management computing device for matching skills sets and jobs;

FIGS. 2A-2B are flowcharts of an exemplary method for matching skills sets and jobs;

FIG. 3 is an exemplary template including candidate information;

FIG. 4 is an exemplary table including a skills and sub-skills of a candidate;

FIG. 5 is an exemplary table illustrating skill set including job skills and job sub-skills in a hierarchical structure;

FIG. 6 is an exemplary table illustrating rating parameters for the skill set of the candidate;

FIG. 7 is an exemplary table illustrating languages and assessment parameters for the languages;

FIG. 8 is an exemplary table illustrating the skills and languages rated by the candidate;

FIG. 9 is an exemplary flowchart illustrating a method for identifying job by matching candidate skill sets and required skills of the job;

FIG. 10 is an exemplary table illustrating a calculation involved in determining a percentage match;

FIG. 11 is an exemplary table illustrating the identified job opportunities for the candidate;

FIG. 12 is an exemplary flowchart of method for providing candidate profiles to an employer computing device; and

FIG. 13 is an exemplary flowchart illustrating a method for determining a percentage of a profile match to provide candidate profiles to the employer computing device.

### DETAILED DESCRIPTION

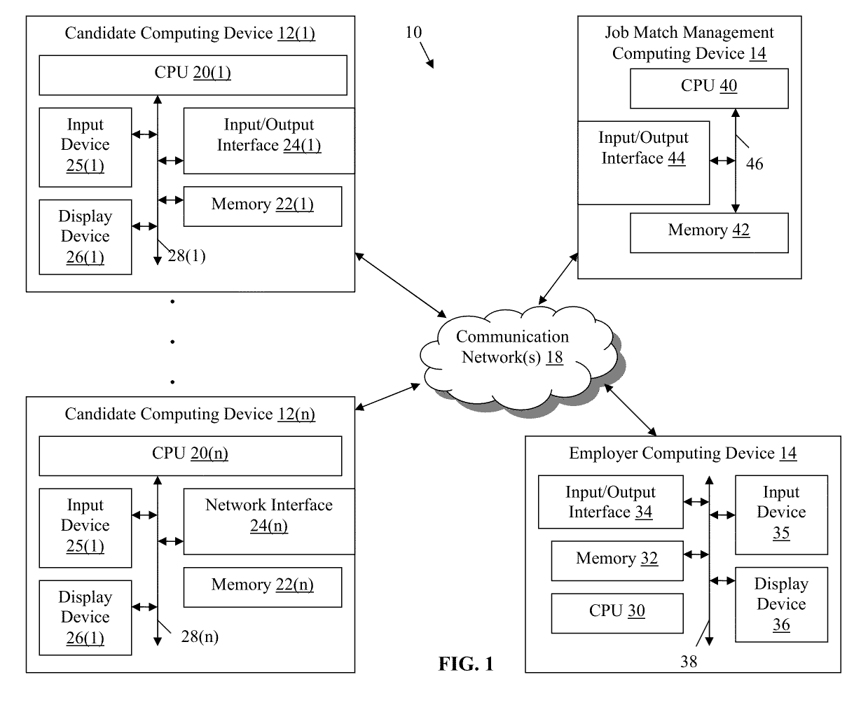

An exemplary environment 10 with candidate computing devices 12(1)-12(n) and an employer computing device 14 coupled to a job match management computing device 16 by communication network(s) 18 is illustrated in FIG. 1, although this environment 10 can include other numbers and types of systems, devices, components, and elements in other configurations. While not shown, the environment 10 also may include additional network components which are well known to those of ordinary skill in the art and thus will not be described here. This technology provides a number of advantages including methods, non-transitory computer readable medium, and a job match management computing device that facilitates efficient matching skill sets of a candidate and job opportunity.

The candidate computing devices 12(1)-12(n) in this example each include a central processing unit (CPU) 20(1)-20(n), a memory 22(1)-22(n), an input/output interface 24(1)-24(n), an input device 25(1)-25(n), and a display device 26(1)-26(n), which are coupled together by a bus 28(1)-28(n) or other link, respectively, although each could comprise other types and numbers of systems, devices, components or other elements in other configurations. The candidate computing devices 12(1)-12(n) can also have other numbers and types of systems, devices, components, and elements in other configurations and locations. Candidates can use the candidate computing devices 12(1)-12(n) to submit associated skills to the job match management computing device 16, as well as to exchange other information and/or perform other types and numbers of functions.

The CPU 20(1)-20(n) in each of the candidate computing devices 12(1)-12(n) executes a program of stored instructions for one or more aspects of the present technology as described and illustrated by way of the examples herein. Other types and numbers of processing devices and configurable hardware logic could be used and the CPU 20(1)-20(n) in each of the candidate computing devices 12(1)-12(n) could execute other numbers and types of programmed instructions.

The memory 22(1)-22(n) in each of the candidate computing devices 12(1)-12(n) stores these programmed instructions for one or more aspects of the present technology, as described and illustrated herein, although some or all of the programmed instructions could be stored and/or executed elsewhere. The memory 22(1)-22(n) optionally stores programmed instructions for a Web browser for communicating with the input/output interface 24(1)-24(n) to operatively exchange content with the job match management computing device 16. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the CPU 20(1)-20(n), can be used for the memory 22(1)-22(n).

The input/output interface 24(1)-24(n) in each of the candidate computing devices 12(1)-12(n) is used to operatively couple and communicate between the candidate computing device 12(1)-12(n) and the job match management computing device 16 via the communication network(s) 18, although other types and numbers of connections or configurations can also be used. By way of example only, the communication network(s) 18 could use TCP/IP over Ethernet and industry-standard protocols and can include one or more local area networks or wide area networks and 3G and 4G telecommunication networks, for example.

The input device 25(1)-25(n) in each of the candidate computing devices 12(1)-12(n) is used to enable a user to interact with the candidate computing device 12(1)-12(n), such as to input data or to configure, program, or operate the candidate computing device 12(1)-12(n) by way of example only. Input devices may include a keyboard, computer mouse, or touch screen, for example, although other types and numbers of input devices could also be used.

The display device 26(1)-26(1) in each of the candidate computing devices 12(1)-12(n) is used to enable a candidate to view data and information output or provided by the candidate computing device 12(1)-12(n). Display devices 26(1)-26(n) may include a computer monitor or a touch screen, although other types and numbers of display devices could also be used.

The employer computing device 14 in this example includes a central processing unit (CPU) 30, a memory 32, an input/output interface 34, an input device 35, and a display device 36, which are coupled together by a bus 38 or other link. The employer computing device 14 can also have other numbers and types of systems, devices, components, and elements in other configurations and locations. An employer or recruiter can use the employer computing device 14 to submit required skills for a job to the job match management computing device 16, select potential candidates for the job requirements, view and compare previously selected candidates, and to exchange other information with the job match management computing device 16 and/or to perform other functions.

The CPU 30 in the employer computing device 14 executes a program of stored instructions for one or more aspects of the present technology as described and illustrated by way of the examples herein. Other types and numbers of processing devices and configurable hardware logic could be used and the CPU 30 in the employer computing device 14 could execute other numbers and types of programmed instructions.

The memory 32 in the employer computing device 14 stores these programmed instructions for one or more aspects of the present technology, as described and illustrated herein, although some or all of the programmed instructions could be stored and/or executed elsewhere. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the CPU 30, can be used for the memory 32.

The input/output interface 34 in the employer computing device 14 is used to operatively couple and communicate between the employer computing device 14 and the job match management computing device 16 via the communication network(s) 18, although other types and numbers of connections or configurations can also be used.

The input device 35 in the employer computing device 14 is used to enable a user to interact with the employer computing device 14, such as to input data or to configure, program, or operate the employer computing device 14 by way of example only. The input device may be a keyboard, computer mouse, or touch screen, for example, although other types and numbers of input devices could also be used.

The display device 36 in the employer computing device 14 is used to enable a user to view data and information output or provided by the employer computing device 14. The display device 36 may be a computer monitor or a touch screen, although other types and numbers of display devices could also be used.

The job match management computing device 16 includes a central processing unit (CPU) 40, a memory 42, and an input/output interface 44, which are coupled together by a bus 46 or other link, although other numbers and types of systems, devices, components, and elements in other configurations and locations can also be used. The CPU 40 in the job match management computing device 16 executes a program of stored instructions for one or more aspects of the present technology as described and illustrated by way of the examples herein, although other types and numbers of processing devices and configurable hardware logic could be used and the CPU 40 could execute other numbers and types of programmed instructions.

The memory 42 in the job match management computing device 16 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the CPU 40, can be used for the memory 42.

The input/output interface 44 in the job match management computing device 16 is used to operatively couple and communicate between the job match management computing device 16, the candidate computing devices 12(1)-12(n), and the employer computing device 14 via the communication network(s) 18, although other types and numbers of connections and configurations can also be used.

Although examples of the job match management computing device 16, the candidate computing devices 12(1)-12(n), and employer computing device 14, which are coupled together via the communication network(s) 18, are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skilled in the art.

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

It is to be understood that the methods of the examples described herein are for exemplary purposes, as many variations of the specific hardware and software used to implement the examples are possible, as will be appreciated by those skilled in the relevant art(s).

Furthermore, each of the methods of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

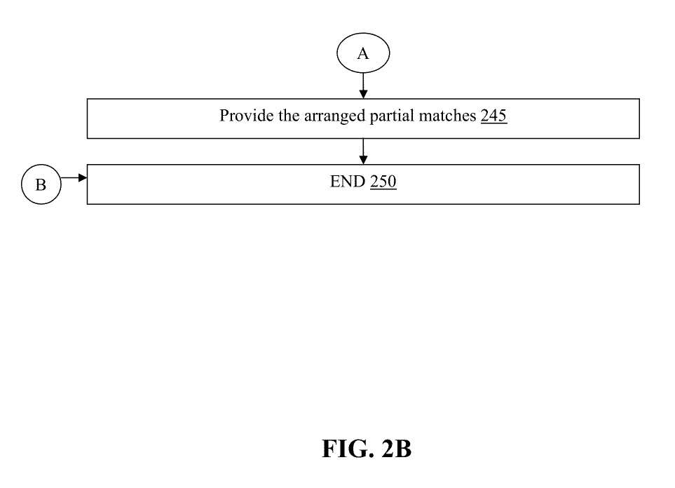

An exemplary method for matching skill sets and job opportunities will now be described with reference to FIGS. 1-13. The exemplary method begins at step 205 where, the job match management computing device 16 receives, from the candidate computing devices 12(1)-12(n), candidate information including identifying information and a plurality of job skills of the candidate. By way of example only, the candidate profiles can be input through form(s) requested by users of the candidate computing devices 12(1)-12(n) using a web browser executed on the candidate computing devices 12(1)-12(n) as illustrated in FIG. 3. In this example, the candidate information received by the job match management computing device includes education level, working environment, availability, the type of profession or the designation of the candidate is currently working, desired job location, languages, willingness to relocate, preferred location, willingness to travel, current compensation, expected compensation and desired designation, although job match management computing device 16 may receive other additional information associated with the candidate.

Next, in step 210, the job match management computing device 16 stores the received candidate information in a database in the memory 42 to create a candidate profile, for example, although other storage methods and locations can also be used. Optionally, the user of one of the candidate computing devices 12(1)-12(n) can access the stored candidate information and edit the stored candidate information using login credentials such as username and password, although other techniques can be used to access and edit the stored candidate information.

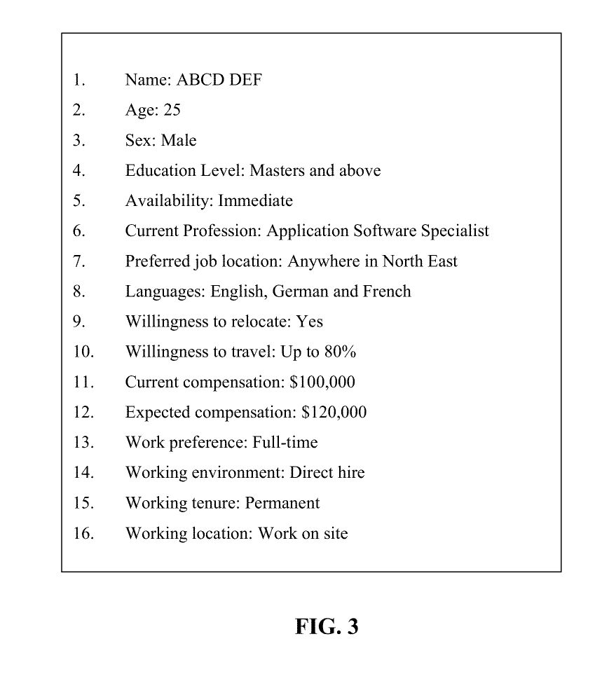

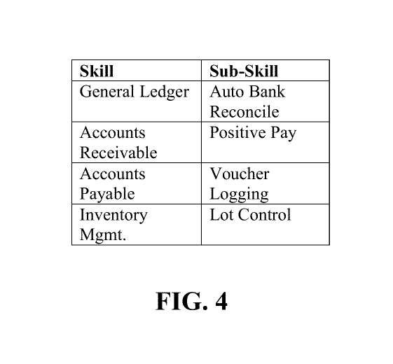

In step 215, the job match management computing device 16 receives the job skills and job sub-skills associated with each of the candidates from one or more of the candidate computing devices 12(1)-12(n). In this example, the job match management computing device 16 provides selectable forms on a web page including skill sets represented in a searchable hierarchical structure to the candidate computing devices 12(1)-12(n). The skill sets includes job skills and associated job sub-skills hierarchically represented as illustrated in FIG. 5. By providing the skill set in a hierarchical structure, the technology provides advantages of more easily finding and more flexibility in selecting the job-skills and job sub-skills. By way of example only, in FIG. 5, the job-skill “Graphic Design” and the associated job sub-skill “Adobe Illustrator” may be found through path 1, path 2 or path 3. Next, the job match management computing device 16 receives the job skills and the associated job sub-skills of the candidate by candidate selecting the job skills and job sub-skills present in the form using the candidate computing device 12(1)-12(n) such as illustrated in FIG. 4, although other methods and techniques can be used to receive the job skills and associated job sub-skills of the candidate. Additionally, in this step, the job match management computing device 16 stores the received job skills in the candidate profile created in step 210.

Upon receiving the job skills and job sub-skills, in step 220, the job match management computing device 16 obtains previously stored rating parameters to the requesting one of the candidate computing device 12(1)-12(n) to rate or assess each of the received job sub-skill or job sub-skills via an interface, although job match management computing device 16 can provide the obtained job skill or job sub-skill and the rating parameter using other techniques. A variety of different types of rating parameters could be used. By way of example only, the rating parameter can be either a simple Yes or NO, if the type of job-skill or job sub-skill requires a license or certification, or the rating parameter can be an evaluation rating on a scale of 0-5, where 0 relates to no knowledge, 1 relates to some knowledge, 2 relates to moderate knowledge, 3 relates to good knowledge, 4 relates to very good knowledge or 5 relates to expert knowledge or on a scale of 0 to 100, where 0 is an indication of low level of expertise and 100 is an indication of high level of expertise.

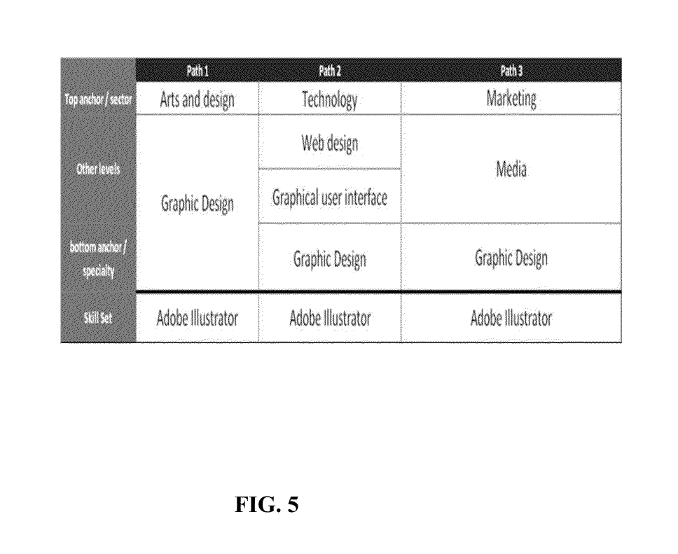

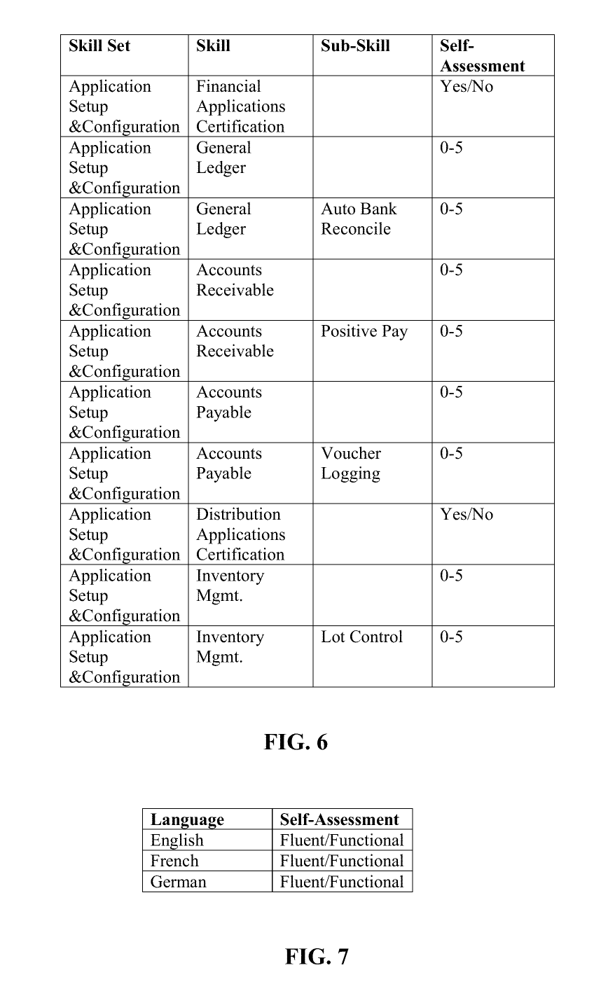

In this example, the rating parameter received for the job skill or job sub-skill for financial applications certification is Yes/No and the rating parameter for the job skills relating to: general ledger; accounts receivable; accounts payable; and inventory management is on a scale of 0-5, as illustrated in FIG. 6. Additionally, for languages, the job match management computing device 16 provides the rating parameters in yet another possible format as none, functional, or fluent as illustrated in FIG. 7, although other rating parameters could be used.

Next, in step 230, job match management computing device 16 determines if it has received a selection of the rating parameters for one or more of the job skills or job sub-skills from one of the requesting candidate computing device 12(1)-12(n). If job match management computing device 16 determines that it has not received a selection, then a No branch is taken to step 250, where this example of the method ends. However, if job match management computing device 16 determines that it has received a selection, then the Yes branch is taken to step 232.

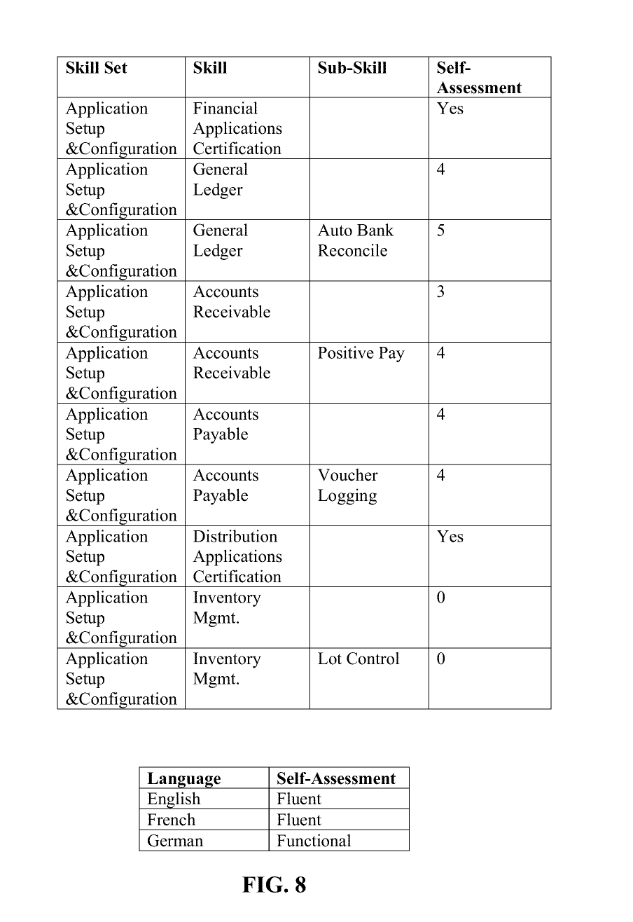

By way of example only, a received selection of rating parameters for job skills and sub-skills from one is illustrated in FIG. 8. Additionally, the job match management computing device 16 also stores the received selection of the rating parameter in the candidate profile within the memory 42 of the job match management computing device 16.

In step 232, the job match management computing device 16 determines if the assessments have been properly completed. For example, the job match management computing device 16 may determine whether any of the job skills or job sub-skills are missing an assessment, if the entered assessment is not within the range of possible options, or if one or more criteria for selecting the assessment ratings are not satisfied. By way of example only, there may be stored criteria and programmed instructions that only allow a candidate to select the highest assessment rating for a job skill a stored number of times and then other lower assessment ratings must be entered for the other job skills of the candidate.

Optionally, in this example, job match management computing device 16 may also verify the received selection of the rating parameters by requesting the candidate computing device 12(1)-12(n) to provide verification of any certification or can request a peer of the candidate to verify the rating of the candidate for each of the job sub skills. If in step 232, the job match management computing device 16 determines the assessments have not been properly completed, then the No branch is taken back to step 230. If in step 232, the job match management computing device 16 determines the assessments have been properly completed, then the Yes branch is taken back to step 235.

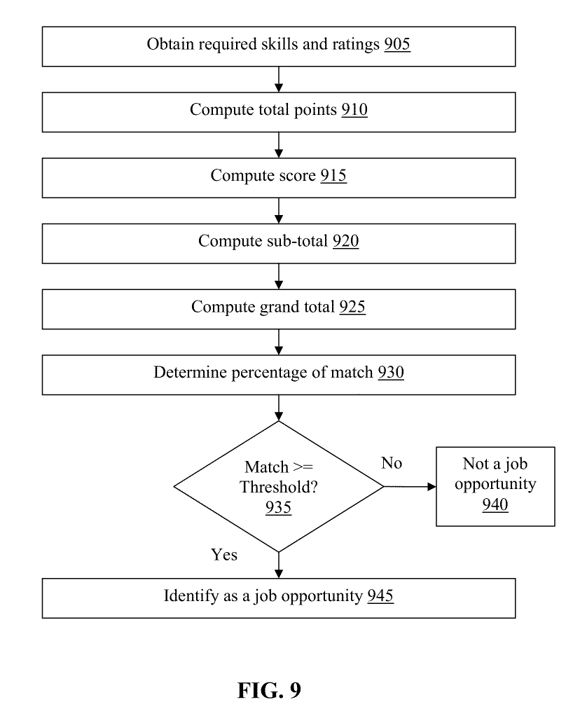

Next, in step 235, job match management computing device 16 identifies one or more job opportunities by matching the rated and assessed job skill or sub-skill of the candidate to ratings assigned to the required skills for the job opportunities, although job match management computing device 16 can identify job opportunities by matching one or more of the job skill sets and the requirement of the job opportunities using other parameters. By way of example only, the job match management computing device 16 compares each rated and assessed job sub-skill of the candidate with ratings assigned to each of required skill of the job opportunities to determine a percentage of match. In this example, although there is no requirement for each of the assessed job-skill set to match with each of the required skill of the job opportunities, the job match management computing device 16 checks if the determined percentage of match is above a required threshold to decide whether the job skill set of the candidate matches with the one or more job opportunities, although other techniques or methods can be used to determine the match. An example of a method for matching candidates to one or more job opportunities by determining a percentage of match, will now be further described using the flowchart illustrated in FIG. 9.

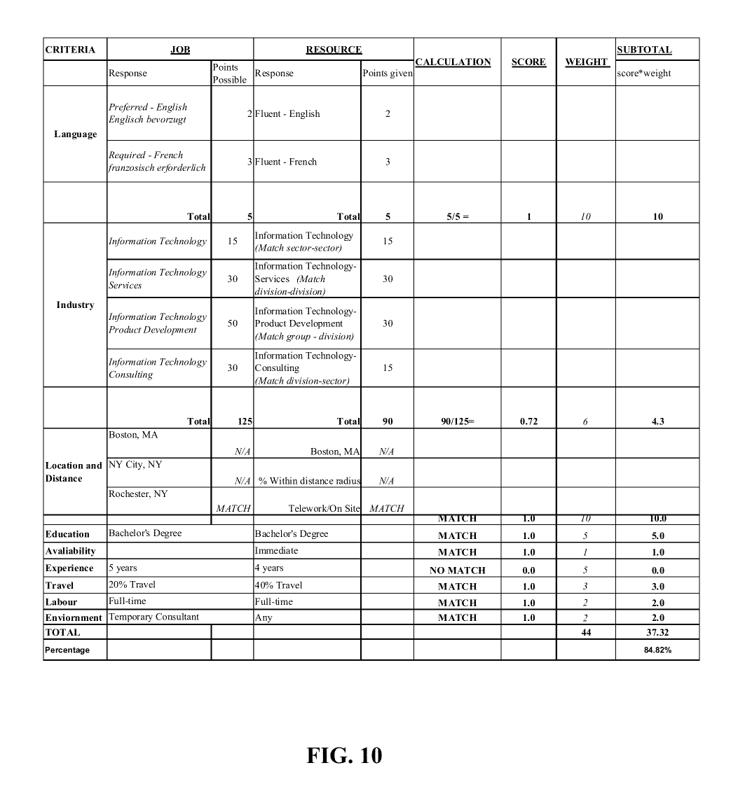

Referring to FIG. 9, in step 905 the job match management computing device 16 obtains the required skills, required sub skills and stored ratings (possible points as illustrated in FIG. 10) associated with the all job opportunities stored within the memory 42, although the job match management computing device 16 can retrieve the required skills and ratings from other memory locations. In this example, the stored rating of the required skills and required sub-skills correlate to the assessment rating of the candidate as previously illustrated, although the stored ratings can be in other formats which can assist the job match management computing device 16 with matching candidates with one or more job opportunities. By way of example only, the required skills of the job opportunity can be requirements for a particular fluency of language such as English and French, expertise in a particular industry such as information technology services or product development or consulting, willingness to work at a defined location, such as Boston, Mass., required education such as a Bachelors Degree as illustrated in FIG. 10.

Next in step 910, the job match management computing device 16 computes total points (total) of the required skills or required sub-skills of the job opportunity by adding all the stored ratings of each of the required skills or required sub-skills and computes the total rating for each job skill allocated by the candidate (points given as illustrated in FIG. 10) by adding all the rating parameters of the job skill or job sub-skills as further illustrated in FIG. 10.

Upon calculating the total points, in step 915 the job match management computing device 16 computes the score value for each of the required skill by dividing the total points of the rating allocation by the candidate (points given) and the total of the possible points for each required skill for the job opportunity as illustrated in FIG. 10. Additionally, when there is an exact match between the one of the required skill of the job opportunity and the job skill of the candidate (education level required by job opportunity is Bachelors degree and education level of the candidate is Bachelors degree as illustrated in FIG. 10), the job match management computing device 16 assigns a score value 1. However, when there is not an exact match between one of the required skill of the job opportunity and the job skill of the candidate (experience required by job opportunity is 5 years and the experience of the candidate is 4 years), the job match management computing device 16 assigns a score value of 0. In another example, the job match management computing device 16 may assign values between 0 and 1 (such as 0.1, 0.2 etc).

Next in step 920, the job match management computing device 16 multiplies the computed score with a stored weight value assigned to each required skill of the job opportunity to compute a weighted score value as illustrated in FIG. 10. In this example, the weight value is a pre-determined value assigned by the job match management computing device 16 based on the importance of each required skill and information in the job opportunity. By way of example only, the weight can be a number in the range of 1 to 10 where 1 is the lowest weight (least important) and 10 being the highest weight (most important).

Upon determining the weighted score value for each required skill and candidate information, in step 925 the job match management computing device 16 calculates a grand total by adding all the weighted score value calculated in step 920. Additionally, in step 920 the job match management computing device 16 also computes the total weight by adding all the weights assigned to each of the required skills and candidate information as illustrated in FIG. 10.

In step 930, the job match management computing device 16 calculates a percentage match between the candidate job skills and the required skills of the job opportunity by dividing the grand total and the total weight as further illustrated in FIG. 10.

In step 935, the job match management computing device 16 determines if the calculated percentage of match is above a pre-defined required threshold. If the job match management computing device 16 determines that the calculated percentage of match is below a pre-defined required threshold, then a No branch is taken to step 940 where the job match management computing device 16 identifies the job opportunity as not matching the candidate job skill sets and accordingly does not identify the job as a possible job opportunity for the candidate.

However, if the job match management computing device 16 determines that the calculated percentage of match is greater or equal to the pre-defined required threshold, a Yes branch is taken to step 945 where the job match management computing device 16 identifies the job opportunity as a match for the candidate based on the job skill set of the candidate and identifies the job opportunity as a potential job opportunity for the candidate. In this example, the pre-defined required threshold is the percentage which is set based on information obtained from the employer of the job opportunity. The job match management computing device 16 repeats steps 905 to 945 for all the job opportunities available to identify the potential job opportunity for the candidate based on the candidate job skills. By using the techniques illustrated in steps 905 to 945, the technology disclosed here identifies job opportunities to the candidates without using keywords or queries.

Accordingly, in this example, job match management computing device 16 identifies job opportunities which have required skills relating to auto bank reconcile, general ledger, positive pay, accounts receivable, voucher logging, and accounts payable and which requires certification in distributed application certification and financial application certification.

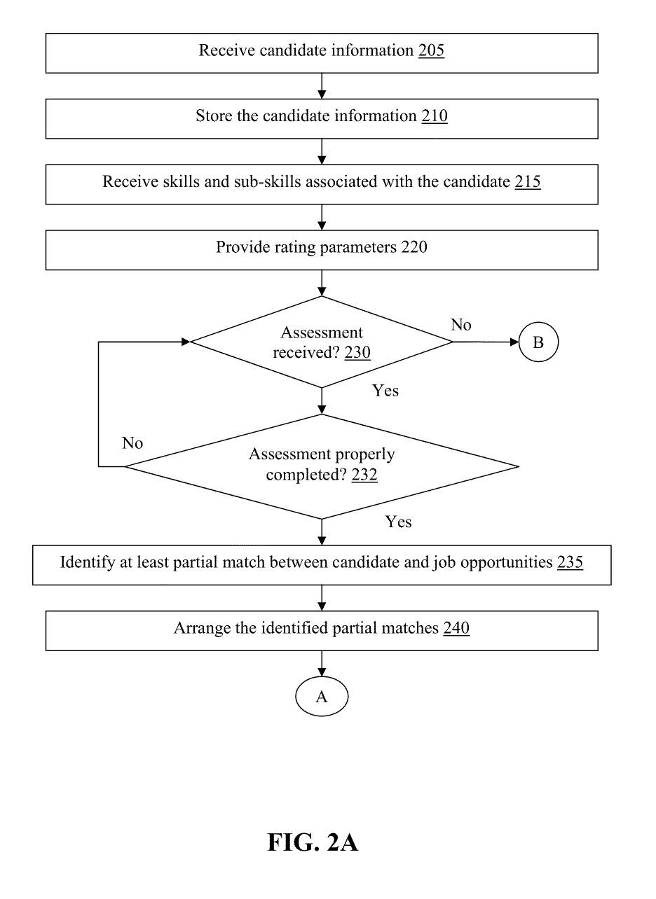

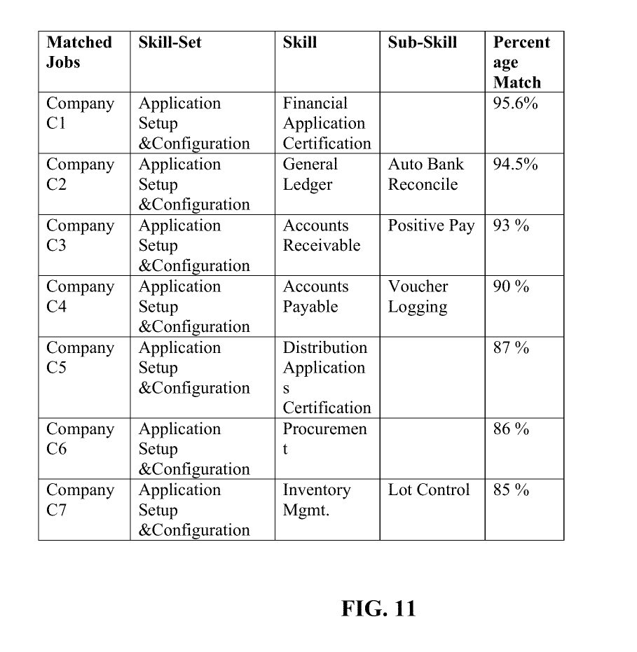

With reference to flowchart illustrated in FIG. 2, upon identifying the jobs, in step 240, the job match management computing device 16 arranges each of the identified matches between the candidate and the job opportunity based on decreasing order of the percentage match as illustrated in FIG. 11, although the job match management computing device 16 can arrange the identified job opportunity based on other parameters.

In step 245, job match management computing device 16 provides the arranged identified matches between the candidate and the job opportunity to the requesting candidate computing device 12(1)-12(n) and the exemplary process ends in step 250.

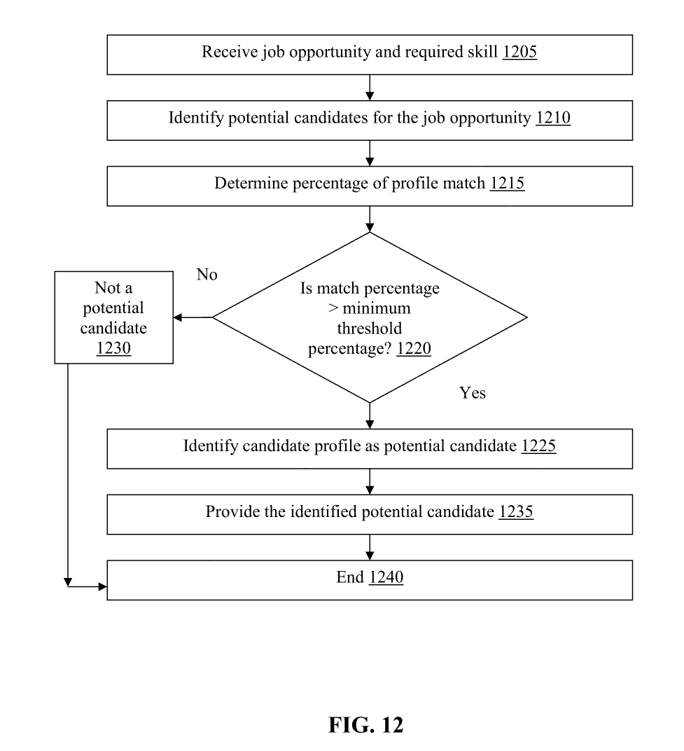

Additionally the job match management computing device 16 can assist employers with finding one or more candidates for a potential job opportunity using as an exemplary process illustrated in FIG. 12. In step 1205, the job match management computing device 16 receives required skills, sub-skills and ratings for each of the required skills and sub-skills for each of the potential job opportunity from a employer computing device 14. By way of example only, the required skills can be work location, compensation, level of education, required certifications, domain expertise, work preferences, although the required skills can include other types or amounts of information associated with a job opportunity.

Next in step 1210, the job match management computing device 16 identifies potential candidates for the potential job opportunity. By way of example only, the job match management computing device 16 identifies potential candidates by obtaining candidate profile identifiers of candidate profile created in step 210 when there is a match between the job skills or job sub-skills of the candidate and the required skills or required sub-skills for a potential job opportunity received from the employer computing device 14, although the job match management computing device 16 can use other techniques to identify potential candidates for the potential job opportunity. Further, for all the obtained candidate profile identifiers, the job match management computing device 16 obtains the candidate profile and these candidate profiles are the potential candidates for the potential job opportunity.

For purpose of further illustration with reference to FIG. 5, the job match management computing device 16 first obtains the candidate profile identifier of candidates having job skills or job sub-skills in “Adobe Photoshop”, which in this example is two candidate profiles. Next, the job match management computing device obtains the candidate profile identifier of candidates having job skills or job sub-skills “Graphic Design”, which in this example are six candidate profiles. Further, the job match management computing device 16 obtains candidate profile identifier of candidates having job skills or job sub-skills “Graphical user interface”, which in this example are four candidate profiles. Similarly, the job match management computing device 16 obtains identifier of candidates having job skills or sub-skills in “Web design” and “Media”, “Arts and design”, “Technology” and “Marketing” to make a total of twenty candidate profiles. Using these candidate profile identifier identifiers, the job match management computing device 16 identifies and obtains the candidate profiles of potential candidates for the job opportunity from the memory 42.

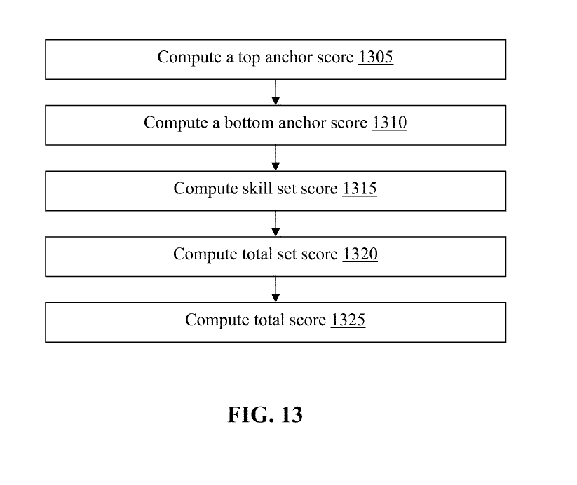

Next, in step 1215, the job match management computing device determines a percentage of profile match for each of the identified potential candidates for the job opportunity using techniques which will now be explained using FIG. 13.

In step 1305, the job match management computing device 16 computes a top anchor score by assigning rating 1 when there is match between the top anchor (job skill of the candidate) and the required skill obtained from the employer computing device 14. However, when there is no match between the top anchor (job skill of the candidate) and the required skill obtained from the employer computing device 14, the job match management computing device 16 assigns a rating 0. In this example, the top anchor score is zero as there is no match between the top anchor (job skill of the candidate) and the required skill obtained from the employer computing device 14.

Next, in step 1310, the job match management computing device 16 computes a bottom anchor score by assigning a rating 1 when there is a match between the bottom anchor (job sub-skills of the candidate) and the required sub-skill of the job obtained from the employer computing device 14. However, when there is no match between the bottom anchor (job sub-skill of the candidate) and the required sub-skill obtained from the employer computing device 14, the job match management computing device 16 assigns a rating 0. In this example, the bottom anchor score is zero as there is no match between the bottom anchor (job sub-skill of the candidate) and the required sub-skill obtained from the employer computing device 14.

In step 1315, the job match management computing device 16 computes a skill set score for each of the skill set and other preferences such as percentage travel, location, contract type of the identified candidate profile. As previously illustrated, the job match management computing device 16 assigns a rating 0 when there is a no match between the required skill set of the job opportunity and job skill set of the candidate. The job match management computing device 16 assigns a rating 1 when there is a match between the required skill set of the job opportunity and job skill set of the candidate. In another example, the job match management computing device 16 can also assign rating between 0 and 1 such as 0.1, 0.2, by way of example only, when the required skill set of the job opportunity is similar to the job skill set of the candidate. In this example, with reference to FIG. 5, the job match management computing device 16, assigns rating 0.0 for user accessibility, 0.82 for Adobe Photoshop. Alternatively, the job match management computing device 16 can obtain the skill set score from a candidate computing device 12(1)-12(N) as previously illustrated in step 220.

Next, in step 1320, the job match management computing device 16 computes a total set score by multiplying the each of the skill set score (either computed or obtained from a candidate computing device 12(1)-12(N)) with a weighted value and then dividing the multiplied value with the total number of skill sets of the candidate, although the job match management computing device 16 can computer the total set score using other parameters. In this example, the job match management computing device 16 receives the weighted values for each of the skill set from the employer computing device 14, although the job match management computing device 16 can obtain the weighted value from other locations or devices. By way of example only, the total set score for the candidate with each skill set having weighted value 1 would be (0.0 (skill set score of user accessibility)*1+0.82 (skill set score of Adobe Photoshop)*1)/2=0.41.

Next, in step 1325, the job match management computing device 16 computes a total score by multiplying the top anchor score computed in 1305, bottom anchor score computed in step 1310 and the total set score computed in step 1315 with a second set of weighted values obtained from the employer computing device 16. Additionally, the job match management computing device 16 adds the multiplied values and divides the final value by 10 to compute the total score, although the job match management computing device 16 can computer the total score using other techniques or parameters. For purpose of better illustration, in this example, total score is equal to [2*(top anchor score)+3*(bottom anchor score)+5*(set score)]/10, which is 35.5%. The total score in percentage illustrates the percentage of profile match for each of the identified potential candidates for the job opportunity.

With reference to FIG. 12, in step 1220, the job match management computing device 16 determines if the determined percentage of profile match is greater than a minimum threshold percentage for a profile match. If the job match management computing device 16 determines that percentage of profile match is greater than the minimum threshold percentage of profile match, then a Yes branch is taken to step 1225, where the corresponding candidate profile is added as a potential candidate profiles for the job opportunity provided to the employer computing device 14.

However, if the job match management computing device 16 determines that the percentage of profile match is less than the minimum threshold percentage of profile match, a No branch is taken to step 1230 where the corresponding candidate profile is not added as a potential candidate for the job opportunity provided to the employer computing device 14.

The job match management computing device 16 performs steps 1305 to 1325 for each of the candidate profile identified in step 1210 to identify the potential candidates for the job opportunity provided by the employer computing device 14.

In step 1235, the job match management computing device 16 provides the profiles of the potential candidates to the employer computing device 14 and the exemplary process ends in step 1240. In this example, if the number of potential candidates provided by the job match management computing device 16 is lesser than the required candidates, the employer using the employer computing device 14 can reduce the minimum threshold percentage of profile match so that more number of candidate profiles could be identified by the job match management computing device 16 as potential candidates for the job opportunity.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for matching a candidate with a job, the method comprising:
obtaining, by a job match management computing device, candidate information and one or more job skills of one or more candidates at one or more candidate computing devices;
obtaining, by the job match management computing device, one or more required skills of one or more job opportunities;
identifying, by the job match management computing device the one or more candidates with the obtained job skills which at least partially match the obtained required skills of one or more of the job opportunities; and
providing, by the job match management computing device, the identified at least partial matches between the one or more candidates and the one or more job opportunities.

2. The method as set forth in claim 1 wherein the identifying further comprises:
obtaining, by the job match management computing device, one or more job sub skills associated with the one or more skills from the candidate computing device and a self assessment rating for one or more of the obtained job skills of the one or more candidates;
obtaining, by the job match management computing device, one or more required sub skills associated with one or more of the obtained required skills of the one or more job opportunities and a stored rating for one or more of the obtained sub-skills for one or more of the job opportunities; and
determining, by the job match management computing device, a job skill score value for each of the obtained job skills of the one or more candidates by adding the obtained self assessment rating for the one of the one or more of the obtained job sub-skills to obtain a total rating, adding the obtained stored rating of one or more of the obtained job sub-skills to obtain total points, and dividing the computed total rating by the computed total points.

3. The method as set forth in claim 2 further comprising:
determining, by the job match management computing device, a weighted score value for each of one or more of the obtained job skills of the one or more candidates and one or more of the obtained required skills of the one or more job opportunities by multiplying the determined job skill score value for each of one or more of the obtained job skills by a corresponding weight value assigned to one or more of the obtained job skills; and
determining, by the job match management computing device, a grand-total by adding each of the determined weighted score values and a total weight value by adding all of the corresponding weight value assigned to one or more of the obtained job skills.

4. The method as set forth in claim 3 further comprising:
determining, by the job match management computing device, a percentage match by diving the determined grand-total and the determined total weight value; and
determining, by the job match management computing device, whether the determined percentage match is above a stored threshold percentage to identify one or more of the candidates with the obtained job skills which at least partially match one or more of the obtained required skills of one or more of the job opportunities.

5. The method as set forth in claim 4 further comprising providing, by the job match management computing device, the identified at least partial matches between the one or more candidates and the one or more job opportunities when the determined percentage above the stored threshold percentage.

6. The method as set forth in claim 5 further comprising arranging, by the job match management computing device, identified at least partial matches between the one or more candidates and the one or more job opportunities based on the determined percentage match.

7. The method as set forth in claim 1 wherein the obtaining the one or more job skills of the one or more candidates further comprises, obtaining, by the job match management computing device, the one or more job skills of the one or more candidates via a web page comprising selectable forms, wherein the one or more job skills are represented in a hierarchical format.

8. A non-transitory computer readable medium having stored thereon instructions for matching a candidate with a job comprising machine executable code which when executed by at least one processor, causes the processor to perform steps comprising:
obtaining, candidate information and one or more job skills of one or more candidates at one or more candidate computing devices;
obtaining, one or more required skills of one or more job opportunities;
identifying, the one or more candidates with the obtained job skills which at least partially match the obtained required skills of one or more of the job opportunities; and
providing, the identified at least partial matches between the one or more candidates and the one or more job opportunities.

9. The medium as set forth in claim 8 wherein the identifying further comprises:
obtaining, one or more job sub skills associated with the one or more skills from the candidate computing device and a self assessment rating for one or more of the obtained job skills of the one or more candidates;
obtaining, one or more required sub skills associated with one or more of the obtained required skills of the one or more job opportunities and a stored rating for one or more of the obtained sub-skills for one or more of the job opportunities; and
determining, a job skill score value for each of the obtained job skills of the one or more candidates by adding the obtained self assessment rating for the one of the one or more of the obtained job sub-skills to obtain a total rating, adding the obtained stored rating of one or more of the obtained job sub-skills to obtain total points, and dividing the computed total rating by the computed total points.

10. The medium as set forth in claim 9 further comprising:
determining, a weighted score value for each of one or more of the obtained job skills of the one or more candidates and one or more of the obtained required skills of the one or more job opportunities by multiplying the determined job skill score value for each of one or more of the obtained job skills by a corresponding weight value assigned to one or more of the obtained job skills; and
determining, a grand-total by adding each of the determined weighted score values and a total weight value by adding all of the corresponding weight value assigned to one or more of the obtained job skills.

11. The medium as set forth in claim 10 further comprising:
determining, a percentage match by diving the determined grand-total and the determined total weight value; and
determining, whether the determined percentage match is above a stored threshold percentage to identify one or more of the candidates with the obtained job skills which at least partially match one or more of the obtained required skills of one or more of the job opportunities.

12. The medium as set forth in claim 11 further comprising providing, the identified at least partial matches between the one or more candidates and the one or more job opportunities when the determined percentage above the stored threshold percentage.

13. The medium as set forth in claim 12 further comprising arranging, the identified at least partial matches between the one or more candidates and the one or more job opportunities based on the determined percentage of the at least partial match.

14. The medium as set forth in claim 8 wherein the obtaining the one or more job skills of the one or more candidates further comprises, obtaining the one or more job skills of the one or more candidates via a web page comprising selectable forms, wherein the one or more job skills are represented in a hierarchical format.

15. A job match management computing device comprising:
one or more processors;
a memory, wherein the memory coupled to the one or more processors which are configured to execute programmed instructions stored in the memory comprising:
obtaining, candidate information and one or more job skills of one or more candidates at one or more candidate computing devices;
obtaining, one or more required skills of one or more job opportunities;
identifying, the one or more candidates with the obtained job skills which at least partially match the obtained required skills of one or more of the job opportunities; and
providing, the identified at least partial matches between the one or more candidates and the one or more job opportunities.

16. The device as set forth in claim 15 wherein the one or more processors is further configured to execute programmed instructions stored in the memory for the identifying further comprises:
obtaining, one or more job sub skills associated with the one or more skills from the candidate computing device and a self assessment rating for one or more of the obtained job skills of the one or more candidates;
obtaining, one or more required sub skills associated with one or more of the obtained required skills of the one or more job opportunities and a stored rating for one or more of the obtained sub-skills for one or more of the job opportunities; and
determining, a job skill score value for each of the obtained job skills of the one or more candidates by adding the obtained self assessment rating for the one of the one or more of the obtained job sub-skills to obtain a total rating, adding the obtained stored rating of one or more of the obtained job sub-skills to obtain total points, and dividing the computed total rating by the computed total points.

17. The device as set forth in claim 16 wherein the one or more processors is further configured to execute programmed instructions stored in the memory further comprising:
determining, a weighted score value for each of one or more of the obtained job skills of the one or more candidates and one or more of the obtained required skills of the one or more job opportunities by multiplying the determined job skill score value for each of one or more of the obtained job skills by a corresponding weight value assigned to one or more of the obtained job skills; and
determining, a grand-total by adding each of the determined weighted score values and a total weight value by adding all of the corresponding weight value assigned to one or more of the obtained job skills.

18. The device as set forth in claim 17 wherein the one or more processors is further configured to execute programmed instructions stored in the memory further comprising:
determining, a percentage match by diving the determined grand-total and the determined total weight value; and
determining, whether the determined percentage match is above a stored threshold percentage to identify one or more of the candidates with the obtained job skills which at least partially match one or more of the obtained required skills of one or more of the job opportunities.

19. The device as set forth in claim 18 wherein the one or more processors is further configured to execute programmed instructions stored in the memory further comprising providing, the identified at least partial matches between the one or more candidates and the one or more job opportunities when the determined percentage above the stored threshold percentage.

20. The device as set forth in claim 19 wherein the one or more processors is further configured to execute programmed instructions stored in the memory further comprising arranging, the identified at least partial matches between the one or more candidates and the one or more job opportunities based on the determined percentage of the at least partial match.

21. The device as set forth in claim 15 wherein the one or more processors is further configured to execute programmed instructions stored in the memory for the obtaining the one or more job skills of the one or more candidates further comprises, obtaining the one or more job skills of the one or more candidates via a web page comprising selectable forms, wherein the one or more job skills are represented in a hierarchical format.
